(19) United States
(12) Patent Application Publication
(10) Pub. No.: US 2016/0226855 A1
(43) Pub. Date: Aug. 4, 2016

(54) IMAGE FORMING SYSTEM HAVING USER AUTHENTICATION FUNCTION, IMAGE FORMING APPARATUS, METHOD OF CONTROLLING IMAGE FORMING SYSTEM, AND STORAGE MEDIUM

(71) Applicant: CANON KABUSHIKI KAISHA, Tokyo (JP)

(72) Inventor: Akinori Takeo, Yokohama-shi (JP)

(21) Appl. No.: 15/007,764

(22) Filed: Jan. 27, 2016

(30) Foreign Application Priority Data
Jan. 29, 2015 (JP) 2015-015251

(51) Int. Cl. H04L 29/06

(52) U.S. Cl. CPC H04L 63/083; H04L 63/102

(57) ABSTRACT

An image forming system capable of preventing a change in the data structure of information other than information included in a command transmitted to an image forming apparatus, for use in performing user authentication. Upon receipt of a request command for requesting user authentication from a PC as an information processing apparatus, an MFP as the image forming apparatus determines based on the request command by which of a first authentication method not using a token and a second authentication method using a token is to be performed. When the authentication is to be performed by the second authentication method, the token is generated based on the request command and is transmitted to the PC. The token attached to a token-attached command received from the PC is read out therefrom, and the authentication is performed based on the token read out.

### BACKGROUND OF THE INVENTION

1. Field of the Invention

The present invention relates to an image forming system that has a user authentication function, an image forming apparatus, a method of controlling the image forming system, and a storage medium.

2. Description of the Related Art

Conventionally, as an authentication method for an image forming system in which an MFP (Multi-Function Printer) as an image forming apparatus and PCs as information processing apparatuses are connected to each other via a network, it is known to cause the MFP to store items of authentication information each formed by an ID and an associated password in advance, and receive an ID and a password as input information input by a user e.g. via a PC, to thereby authenticate the user when the input information matches any item of the authentication information (hereinafter referred to as the “normal authentication method”). Here, the input information is transmitted form the PC to the MFP in a state included in a command, as communication data, which has a packet structure including a header portion and a command data portion. In the command, the input information is stored in the header portion. Normally, the amount of data of input information stored in the header portion is eight bytes.

Further, as an authentication method for an image forming system in which a plurality of MFPs and a plurality of PCs are connected to each other via a network, it is known to use a token which is a one-time password (hereinafter referred to as the “token authentication method”) (see e.g. Japanese Patent Laid-Open Publication No. 2011-248697).

Incidentally, in recent years, a password used for user authentication has become complicated so as to improve the security level of the MFP.

However, if the password is complicated, it is necessary, for example, in the normal authentication method to increase the capacity of the header portion so as to cope with an increase in the amount of information of the input information, but the capacity of the whole packet is fixed, and hence the capacity of the command data portion is reduced by the increase in the amount of information of the input information.

Incidentally, although the command data portion of the packet stores information other than the input information, such as the command data, since the capacity of the command data portion is reduced by complicating the password as described above, the command data which can be transmitted by one command unless the password is complicated becomes required to be divided and transmitted using a plurality of commands when the password is complicated. Division of the command data is nothing other than changing the data structure of the command data. However, a change in the data structure of the command data has large influence on the MFP and application programs operating on the MFP.

### SUMMARY OF THE INVENTION

The invention provides an image forming system that is capable of preventing a change in the data structure of information other than information included in a command transmitted to an image forming apparatus, for use in performing user authentication, an image forming apparatus, a method of controlling the image forming system, and a storage medium.

In a first aspect of the invention, there is provided an image forming system including an image forming apparatus that performs user authentication by one of a first authentication method which does not use a token and a second authentication method which uses a token, and an information processing apparatus that requests the user authentication to the image forming apparatus, the image forming apparatus comprising a determination unit configured to receive a request command requesting the user authentication from the information processing apparatus, and determine, based on the request command, by which of the first authentication method and the second authentication method, the user authentication is to be performed, a generation unit configured to generate a token based on the request command when it is determined that the user authentication is to be performed by the second authentication method, a read-out unit configured to transmit the token to the information processing apparatus, receive a token-attached command to which the token is attached from the information processing apparatus, and read out the token from the token-attached command, and an execution unit configured to perform the user authentication based on the token read out.

In a second aspect of the invention, there is provided a image forming apparatus that performs user authentication by one of a first authentication method which does not use a token and a second authentication method which uses a token, comprising a determination unit configured to receive a request command requesting the user authentication from an information processing apparatus connected to the image forming apparatus, and determine, based on the request command, by which of the first authentication method and the second authentication method, the user authentication is to be performed, a generation unit configured to generate a token based on the request command when it is determined that the user authentication is to be performed by the second authentication method, a read-out unit configured to transmit the token to the information processing apparatus, receive a token-attached command to which the token is attached from the information processing apparatus, and read out the token from the token-attached command, and an execution unit configured to perform the user authentication based on the token read out.

In a third aspect of the invention, there is provided a method of controlling an image forming system including an image forming apparatus that performs user authentication by one of a first authentication method which does not use a token and a second authentication method which uses a token, and an information processing apparatus that requests the user authentication to the image forming apparatus, comprising receiving a request command requesting the user authentication from the information processing apparatus, determining, based on the request command, by which of the first authentication method and the second authentication method, the user authentication is to be performed, generating a token based on the request command when it is determined that the user authentication is to be performed by the second authentication method, transmitting the token to the information processing apparatus, receiving a token-attached command to which the token is attached from the information processing apparatus, reading out the token from the token-attached command, and performing the user authentication based on the token read out.

In a fourth aspect of the invention, there is provided a non-transitory computer-readable storage medium storing a computer-executable program for executing a method of controlling an image forming system including an image forming apparatus that performs user authentication by one of a first authentication method which does not use a token and a second authentication method which uses a token, and an information processing apparatus that requests the user authentication to the image forming apparatus, wherein the method comprises receiving a request command requesting the user authentication from the information processing apparatus, determining, based on the request command, by which of the first authentication method and the second authentication method, the user authentication is to be performed, generating a token based on the request command when it is determined that the user authentication is to be performed by the second authentication method, transmitting the token to the information processing apparatus, receiving a token-attached command to which the token is attached from the information processing apparatus, reading out the token from the token-attached command, and performing the user authentication based on the token read out.

According to the invention, it is possible to prevent a change in the data structure of information other than information included in a command transmitted to the image forming apparatus, for use in performing user authentication.

Further features of the present invention will become apparent from the following description of exemplary embodiments (with reference to the attached drawings).

### BRIEF DESCRIPTION OF THE DRAWINGS

FIG. 1 is a schematic block diagram of an image forming system according to an embodiment of the invention, which includes an MFP as an image forming apparatus.

FIG. 2 is a schematic function block diagram of the MFP appearing in FIG. 1.

FIG. 3 is a schematic function block diagram of a PC appearing in FIG. 1.

FIG. 4 is a diagram useful in explaining an authentication method-setting screen displayed on a console section of the MFP shown in FIG. 2 or a display section of the PC shown in FIG. 3.

FIG. 5 is a flowchart of a token generation process performed by a CPU of the MFP shown in FIG. 2.

FIG. 6 is a diagram useful in explaining a token generation request command received in the token generation process in FIG. 5.

FIG. 7 is a diagram useful in explaining an authentication information input screen for inputting an ID and a password used in the token generation request command shown in FIG. 6.

FIG. 8 is a flowchart of a transmission process performed by a CPU of the PC shown in FIG. 3, for transmitting a token-attached command.

FIG. 9 is a diagram useful in explaining the token-attached command generated in the transmission process in FIG. 8.

FIG. 10 is a flowchart of a reception process performed by the CPU of the MFP shown in FIG. 2, for receiving the token-attached command.

FIG. 11 is a flowchart of a token authentication process performed in a step in FIG. 10.

FIG. 12 is a flowchart of a variation of the token generation process in FIG. 5.

FIG. 13 is a diagram useful in explaining a token generation request command received in the token generation process in FIG. 12.

### DESCRIPTION OF THE EMBODIMENTS

The present invention will now be described in detail below with reference to the accompanying drawings showing embodiments thereof.

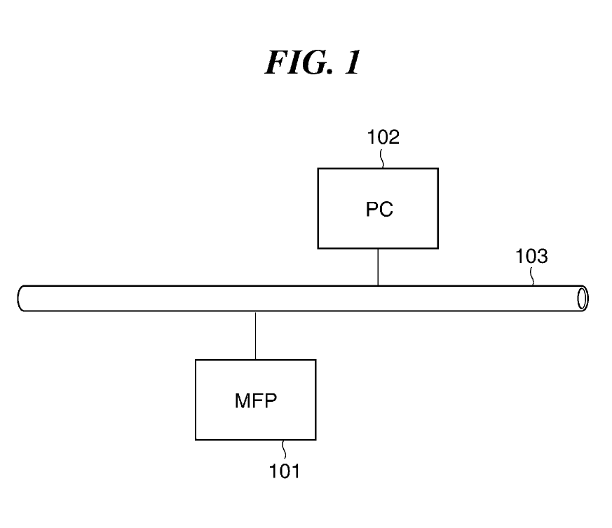

FIG. 1 is a schematic block diagram of an image forming system 100 according to an embodiment of the invention, which includes an MFP 101 as an image forming apparatus.

The image forming system 100 shown in FIG. 1 includes the MFP 101 and a PC 102 as an information processing apparatus, and the MFP 101 and the PC 102 are connected to each other via a network, such as LAN 103. The MFP 101 receives image data transmitted from the PC 102 which is a client, and an ID and a password as information for use in performing user authentication.

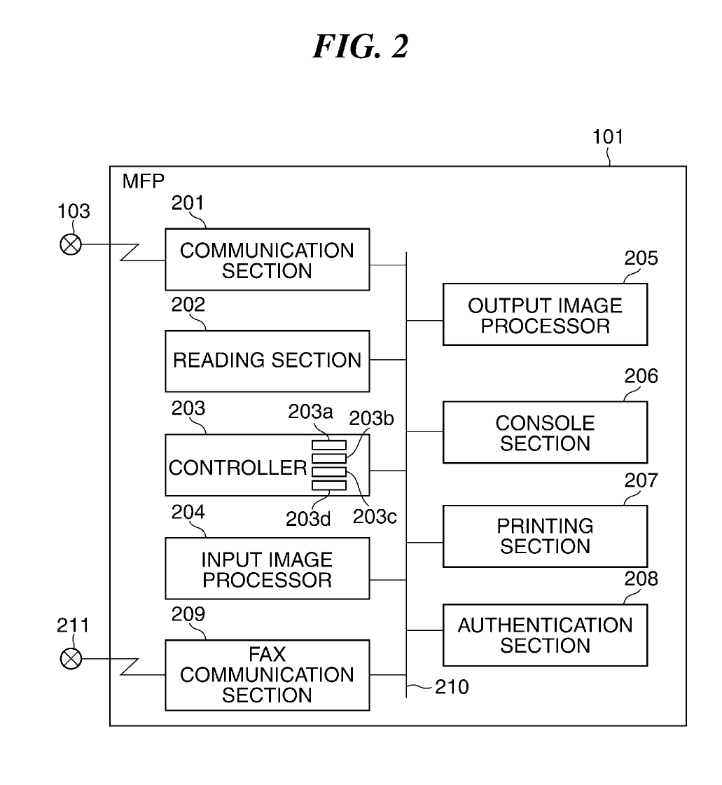

FIG. 2 is a schematic function block diagram of the MFP 101 appearing in FIG. 1.

The MFP 101 shown in FIG. 2 includes a communication section 201, a reading section 202, a controller 203, an input image processor 204, an output image processor 205, a console section 206, a printing section 207, an authentication section 208, and a FAX communication section 209, and these components are interconnected via a bus 210. Further, the communication section 201 is connected to the LAN 103.

The communication section 201 receives, for example, image data, a print command, a command concerning settings of the MFP 101, a management command for managing a job, a print job, a scan job, and a FAX transmission job, from the PC 102 via the LAN 103. The reading section 202 reads an original, and generates image data corresponding to the read original.

The controller 203 includes a CPU 203a, a RAM 203b, a ROM 203c, and an HDD 203d. The CPU 203a executes programs stored in the RAM 203b to thereby control the operation of the MFP 101. The RAM 203b stores various programs, and image data received from the PC 102. The ROM 203c stores various programs executed by the CPU 203a, various data, and so forth. The HDD 203d is a nonvolatile storage device, and stores various programs, various data, and so forth.

The input image processor 204 performs predetermined image processing, such as shading correction processing and MTF correction processing, on image data generated by the reading section 202. The output image processor 205 performs predetermined image processing, such as rasterization processing, monochromatic processing, monochrome color conversion processing, additional image synthesis processing, or halftone processing, on image data processed by the input image processor 204 and image data input from the communication section 201. The console section 206 includes hard keys and an operation panel, and a user inputs an instruction to the MFP 101 by operating the hard keys and the operation panel.

The printing section 207 prints, for example, image data generated by the reading section 202 on a recording sheet. The authentication section 208 performs a normal authentication process or a token authentication process, described hereinafter. The FAX communication section 209 preforms FAX communication with an external apparatus via a telephone line 211.

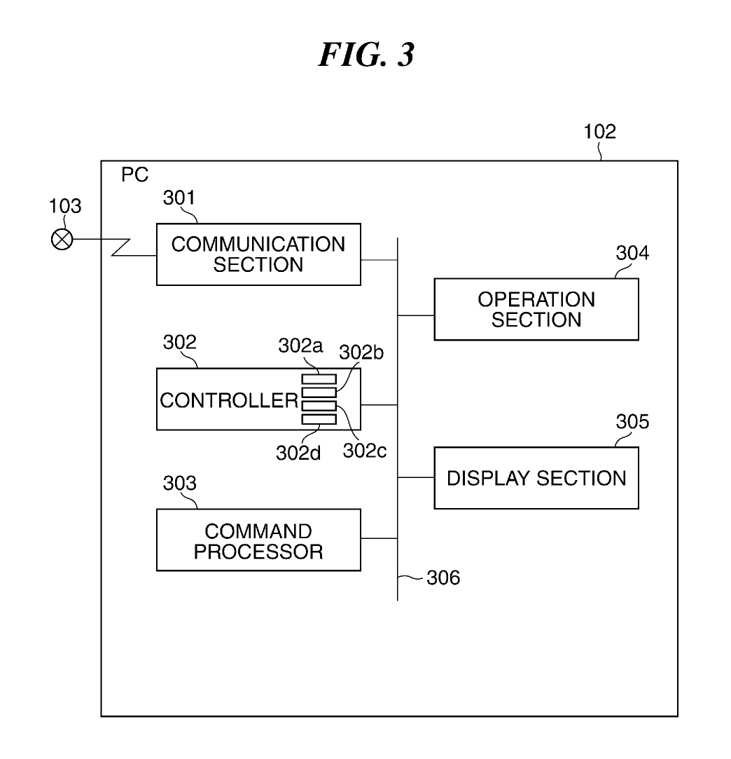

FIG. 3 is a schematic function block diagram of the PC 102 appearing in FIG. 1.

The PC 102 shown in FIG. 3 includes a communication section 301, a controller 302, a command processor 303, an operation section 304, and a display section 305, and these components are interconnected via a bus 306. Further, the communication section 301 is connected to the LAN 103.

The communication section 301 transmits, for example, image data, a print command, a command concerning settings of the MFP 101, a management command for managing a job, a print job, a scan job, or a FAX transmission job, to the MFP 101 via the LAN 103. The controller 302 includes a CPU 302a, a RAM 302b, a ROM 302c, and an HDD 302d, and the CPU 302a executes programs stored in the RAM 302b to thereby control the operation of the PC 102. The RAM 302b stores various programs, and data received from the MFP 101. The ROM 302c stores various programs executed by the CPU 302a, various data, and so forth. The HDD 302d is a nonvolatile storage device, and stores various programs, various data, and so forth. Further, the ROM 302c or the HDD 302d stores a token list, described hereinafter.

The command processor 303 generates various commands. Further, the command processor 303 receives various commands, and interprets the received commands. The operation section 304 is a user interface for input, and is formed, for example, by a mouse and a keyboard. The display section 305 is a user interface for output, and is formed, for example, by an LCD display.

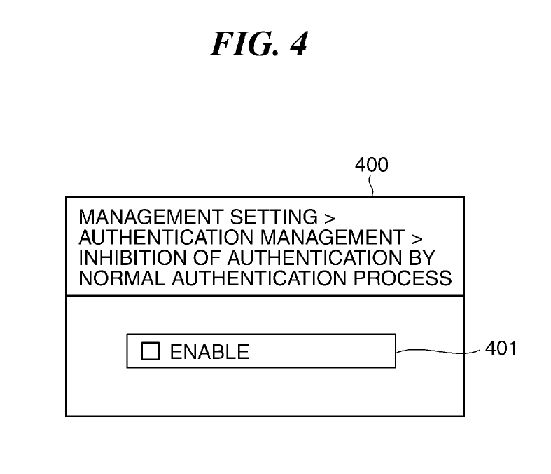

FIG. 4 is a diagram useful in explaining an authentication method-setting screen 400 displayed on the console section 206 of the MFP 101 shown in FIG. 2 or the operation section 304 of the PC 102 shown in FIG. 3. The authentication method-setting screen 400 is used when setting inhibition of user authentication by a normal authentication method (first authentication method) (hereinafter referred to as the “normal authentication process”). The authentication method-setting screen 400 includes a check box 401. When a check mark is input in the check box 401, the normal authentication process is inhibited, and user authentication is performed by a token authentication method (second authentication method) (hereinafter referred to as the “token authentication process”). Note that a setting of inhibition of the normal authentication process may be made not only manually via the authentication method-setting screen 400 as described above, but also automatically in a case where a password for use in the user authentication is complicated, for example, in a case where the password is formed by ten characters of numerals and letters.

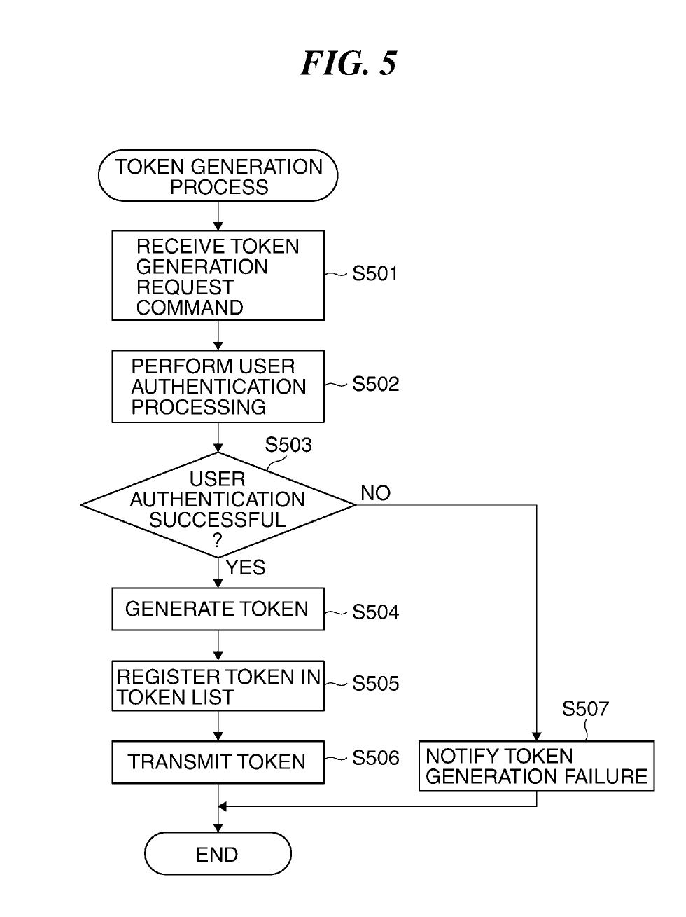

FIG. 5 is a flowchart of a token generation process performed by the CPU 203a of the MFP 101 shown in FIG. 2. In the token generation process in FIG. 5, a token for use in the token authentication process is generated.

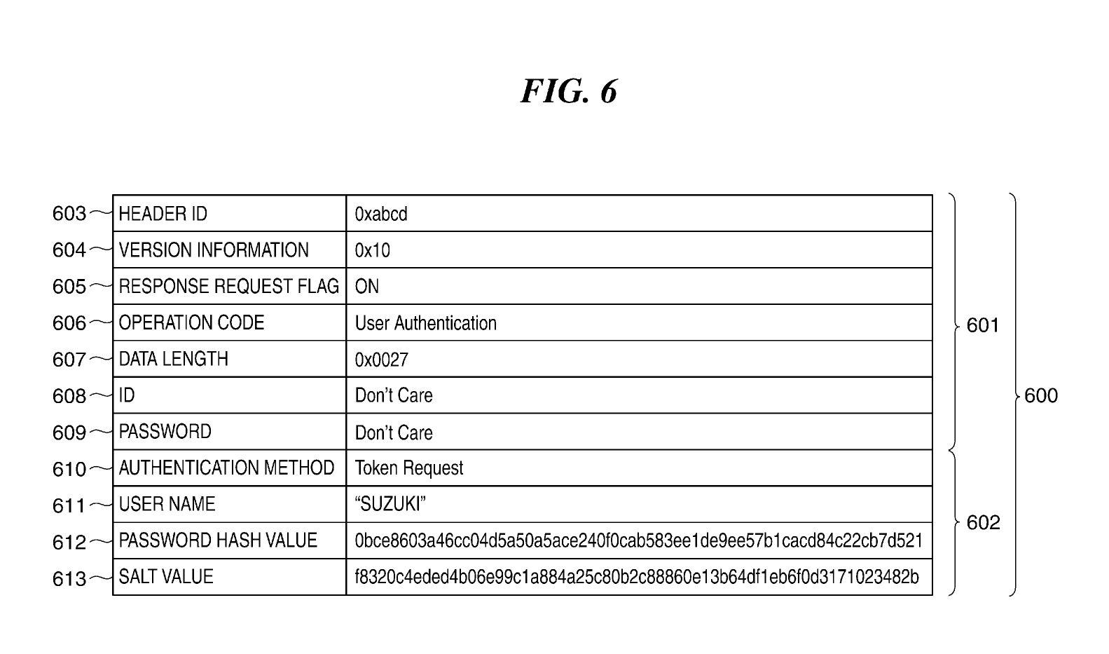

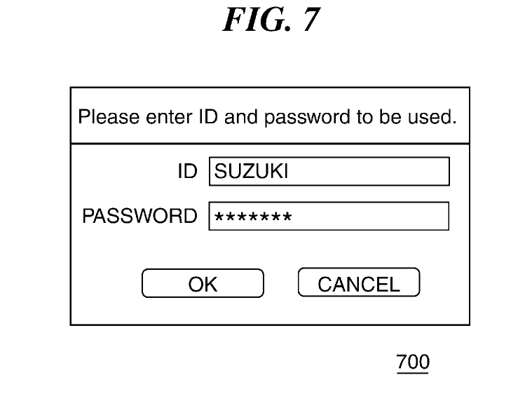

Referring to FIG. 5, first, the CPU 203a receives a token generation request command 600 (see FIG. 6) (step S501). The token generation request command 600 is generated based on an ID and a password input by a user via an authentication information input screen 700 (see FIG. 7) displayed on the display section 305 of the PC 102, and is transmitted from the PC 102 to the MFP 101. As shown in FIG. 6, the token generation request command 600 has a conventional packet structure including a header portion 601 (first header portion) and a command data portion 602 (first data portion). The header portion 601 stores a header ID 603, version information 604, a response request flag 605, an operation code 606, a data length 607, an ID 608, and a password 609, and the command data portion 602 stores an authentication method 610, a user name 611, a password hash value 612, and a salt value 613.

In the header portion 601, the header ID 603 indicates an identifier for identifying a so-called command system. In the illustrated example of the token generation request command 600, as the header ID 603, “0xabcd” is set which is indicative of a command system to which belong the token generation request command 600 and a token-attached command 900 referred to hereinafter. The version information 604 indicates version information of the command system. As the version information 604, “0x10”, for example, is set which is indicative of a version 1.0 of the command system. The response request flag 605 indicates a flag showing whether or not to request the MFP 101 to send back a response when the MFP 101 receives this command transmitted from the PC 102. As the response request flag 605, in the present embodiment, for example, “ON” is set which indicates that the PC 102 requests the MFP 101 to send back a response.

The operation code 606 indicates the type of a command. In the illustrated example of the token generation request command 600, as the operation code 606, “User Authentication” is set which indicates that this command is a command concerning user authentication. When “User Authentication” is set as the operation code 606, the authentication section 208 performs the normal authentication process based on the ID 608 and the password 609, and the authentication information, or performs the token authentication process based on the user name 611, the password hash value 612, and the salt value 613, as well as the authentication information, whereafter the authentication section 208 notifies the PC 102 of a result of execution of either the normal authentication process or the token authentication process. Note that it is apparent from the “0xabcd” of the header ID 603 of the header portion 601 that the token generation request command 600 is a command requesting execution of the token authentication process, and hence the authentication section 208 of the MFP 101 having received the token generation request command 600 executes the token authentication process based on the user name 611, the password hash value 612, and the salt value 613, as well as the authentication information, and notifies the PC 102 of a result of execution of the token authentication process.

The data length 607 indicates a data length, in bytes, of the command data portion 602 of the token generation request command 600. As the ID 608 and the password 609, an ID and a password for use in performing the normal authentication process are set.

In the command data portion 602, in the illustrated example of the token generation request command 600, as the authentication method 610, “Token Request” is set which is indicative of a request for generating a token. When “Token Request” is set as the authentication method 610 as in the case of FIG. 6, “Don't Care”, for example, is set as each of the ID 608 and the password 609 of the header portion 601.

As the user name 611, an ID for use in generating a token is set. As the password hash value 612, a hash value is set which is calculated based on the password and the salt value 613 for use in generating a token.

When generation of a token is requested, the authentication section 208 of the MFP 101 determines whether or not the ID stored in the MFP 101 in advance and the user name 611 match each other, and if the ID and the user name 611 match each other, the authentication section 208 calculates a hash value based on the password stored in the MFP 101 in advance and the salt value 613 of the token generation request command 600. Then, the authentication section 208 determines whether or not the calculated hash value and the value of the password hash value 612 match each other, and if the calculated hash value and the value of the password hash value 612 match each other, the authentication section 208 authenticates the user, and permits the user to use the MFP 101 (success of user authentication).

Referring back to FIG. 5, the CPU 203a performs user authentication processing based on the user name 611, the password hash value 612, and the salt value 613, and the ID and password stored in the MFP 101 in advance (step S502), and determines whether or not the user authentication is successful (step S503).

If it is determined in the step S503 that the user authentication is unsuccessful (fails), the CPU 203a transmits a token generation failure notification for notifying that a token cannot be generated, to the PC 102 (step S507), followed by terminating the present process, whereas if the user authentication is successful, a token is generated (step S504). Here, the generated token is data which has a data amount of 8 bytes and is formed by a token identifier (1 byte) indicating that the data is a token and a random number (7 bytes) created based on a time at which the token is generated. Then, the CPU 203a registers the generated token in the token list (step S505), and transmits the generated token to the PC 102 (step S506), followed by terminating the present process.

Here, the token list is a list in which generated tokens are sequentially registered. When a generated token is registered in the token list, the authentication information stored in the MFP 101 in advance, such as an ID, a password, and information concerning the type of a user (hereinafter referred to as the “user type information”) are associated with the token. That is, the token is registered in the token list in association with the user. Further, the token registered in the token list is deleted from the token list when a command concerning the deletion of the token is received from the PC 102. The command concerning the deletion of the token is transmitted from the PC 102 to the MFP 101 when a predetermined time period, for example, a time period set by the user, elapses after generation of the token.

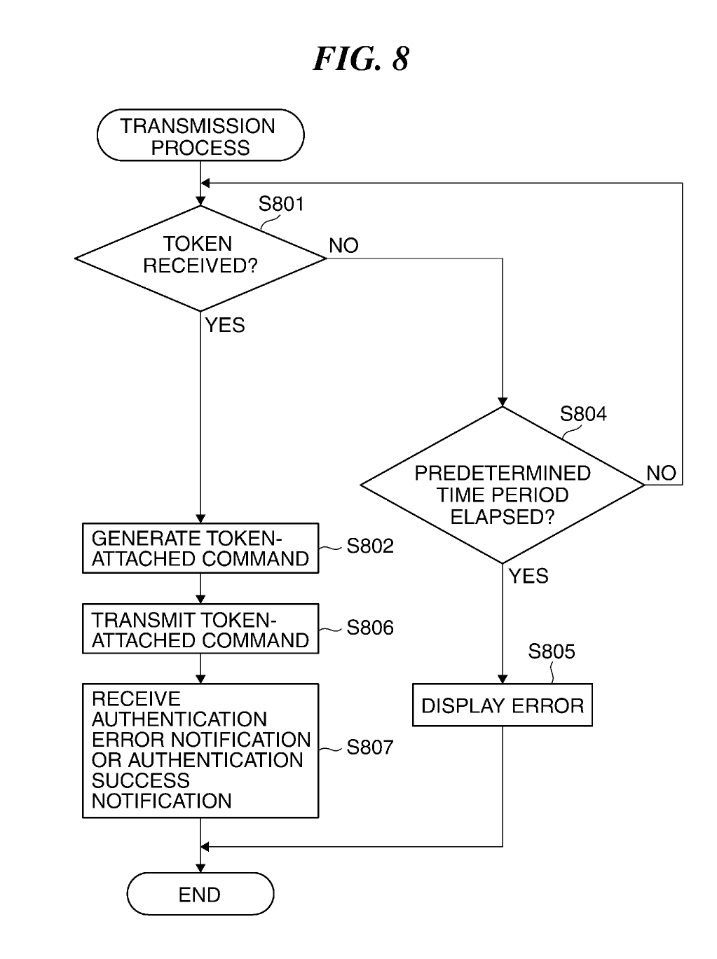

FIG. 8 is a flowchart of a transmission process performed by the CPU 302a of the PC 102 shown in FIG. 3, for transmitting a token-attached command 900.

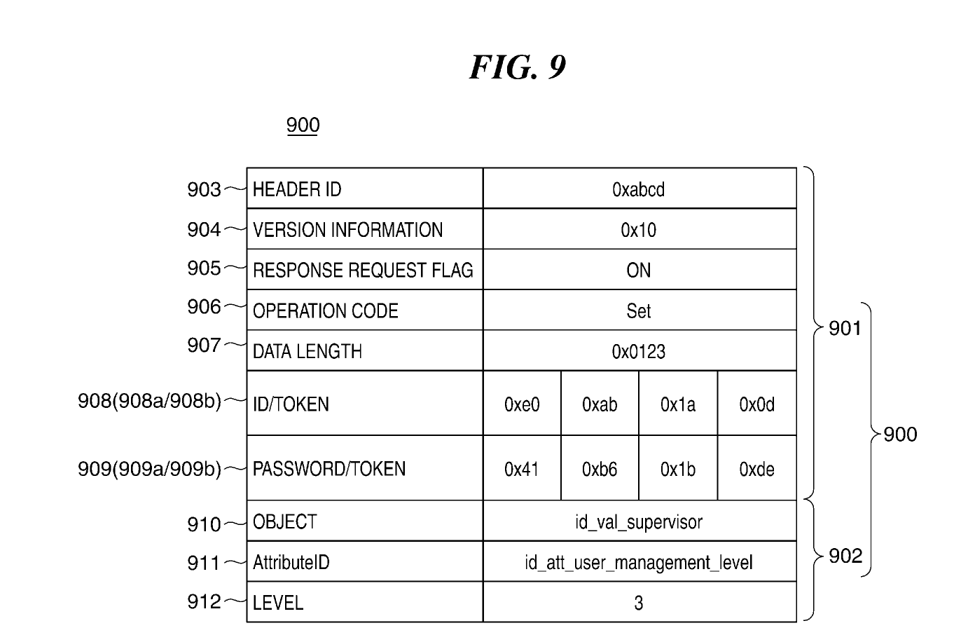

Referring to FIG. 8, first, the CPU 302a determines whether or not the token transmitted from the MFP 101 in the step S506 in FIG. 5 has been received (step S801). If it is determined in the step S801 that the token has been received, the CPU 302a generates the token-attached command 900 (see FIG. 9), described hereinafter (step S802). On the other hand, if the token has not been received, the 302a determines whether or not a predetermined time period has elapsed (step S804). If it is determined in the step S804 that the predetermined time period has not elapsed, the CPU 302a returns to the step S801, whereas if the predetermined time period has elapsed, the CPU 302a displays on the display section 305 an error indicating that the token has not been received (step S805), followed by terminating the present process.

As shown in FIG. 9, the token-attached command 900 is formed by a packet structure including a header portion 901 (second header portion) and a command data portion 902 (second data portion). The header portion 901 stores a header ID 903, version information 904, a response request flag 905, an operation code 906, a data length 907, an ID/token 908 (ID 908a or token 908b), and a password/token 909 (password 909a or token 909b), and the command data portion 902 stores an object 910, an attribute ID 911, and a level 912 as information other than information for use in performing the user authentication.

The header ID 903 indicates an identifier for identifying a so-called command system. For example, as the header ID 903, “0xabcd” is set which is indicative of a command system to which belongs the token-attached command 900. The version information 904 indicates version information of the command system. For example, as the version information 904, “0x10” is set which is indicative of a version 1.0 of the command system. The response request flag 905 indicates a flag showing whether or not to request the MFP 101 to send back a response when the MFP 101 receives this command transmitted from the PC 102. For example, in the present embodiment, as the response request flag 905, “ON” is set which indicates that the PC 102 requests the MFP 101 to send back a response.

The operation code 906 indicates the type of a command. For example, as the operation code 906, “Set” is set which indicates that the token-attached command 900 is a command having a token necessary for user authentication. The data length 907 indicates a data length, in bytes, of the command data portion 902 of the token-attached command 900.

As the ID/token 908, the ID 908a or the token 908b is set. The ID 908a is formed by an ID for use in performing the user authentication by the normal authentication method. As the password/token 909, the password 908b or the token 909b is set. The password 909a is formed by a password for use in performing the user authentication by the normal authentication method. The token 908b set as the ID/token 908 and the token 909b set as the password/token 909 form a token for use in performing the user authentication by the token authentication method. The token is formed by a token identifier (1 byte) and a random number (7 bytes) created based on a time at which the token is generated. The token 908b corresponds to the token identifier (1 byte) and part (3 bytes) of the random number, and the token 909b corresponds to the remaining part (4 bytes) of the random numbers. The token thus set in the token-attached command 900 is a token transmitted from the MFP 101. Note that the token identifier is “0xe0” as a component of the token 908b.

As the object 910, the identifier of a user requesting user authentication is set. As the attribute ID 911, the type of the user who is requesting the user authentication is set, and more specifically, one of guest user, general user, and administrative user is set as the attribute ID 911. For example, in a case where the type of a user is administrative user, “id_att_user_managemnt_level” indicating that the user is an administrative user is set as the attribute ID 911.

As the level 912, the security level required of a user is set. Note that the security level required of a user is different depending on the type of the user. The security level required of an administrative user is Level 3 which is the highest, and the security level required of a guest user is Level 1 which is the lowest. In the illustrated example, as the level 912, “3” is set which indicates that the user requesting user authentication is an administrative user.

Further, the command data portion 902 may include any of various jobs, such as a print job and a FAX transmission job.

Referring back to FIG. 8, when the token-attached command 900 is generated in the step S802, the CPU 302a transmits the generated token-attached command 900 to the MFP 101 (step S806), and receives an authentication error notification or an authentication success notification, referred to hereinafter (step S807), followed by terminating the present process.

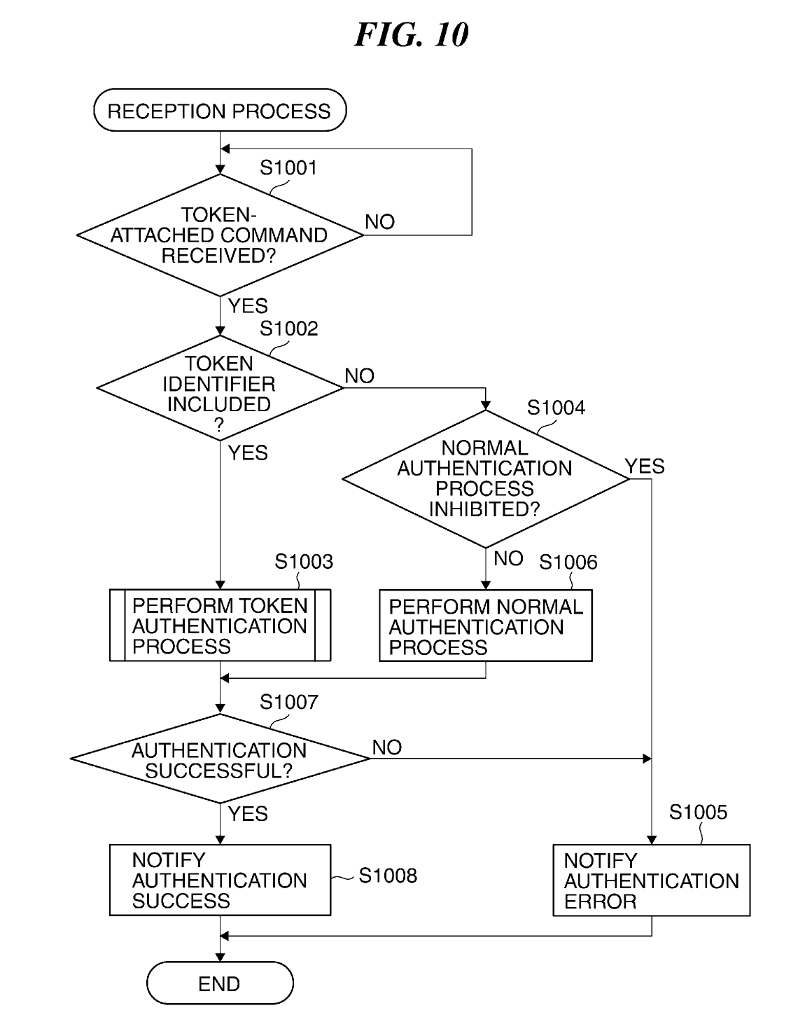

FIG. 10 is a flowchart of a reception process performed by the CPU 203a of the MFP 101 shown in FIG. 2, for receiving the token-attached command 900.

Referring to FIG. 10, first, the CPU 203a determines whether or not the token-attached command 900 transmitted from the PC 102 in the step S806 in FIG. 8 has been received (step S1001). If it is determined in the step S1001 that the token-attached command 900 has not been received, the CPU 203a returns to the step S1001, whereas if the token-attached command 900 has been received, the CPU 203a determines whether or not the received token-attached command 900 includes a token identifier (step S1002). If it is determined in the step S1002 that the token-attached command 900 includes a token identifier, the CPU 203a performs the token authentication process (step S1003), whereas if the token-attached command 900 does not include a token identifier, the CPU 203a determines whether or not inhibition of the normal authentication process is set (step S1004). If it is determined in the step S1004 that inhibition of the normal authentication process is set, the CPU 203a transmits an error notification to the effect that user authentication is not performed (the “authentication error notification” referred to hereinabove) to the PC 102 (step S1005), followed by terminating the present process, whereas if inhibition of the normal authentication process is not set, the CPU 203a performs the normal authentication process (step S1006).

Then, the CPU 203a determines whether or not the token authentication process or the normal authentication process is successful (step S1007). If it is determined in the step S1007 that the user authentication is not successful (fails), the CPU 203a proceeds to the step S1005, whereas if the user authentication is successful, the CPU 203a transmits a notification indicative of success of the user authentication (the “authentication success notification” referred to hereinabove) to the PC 102 (step S1008), followed by terminating the present process.

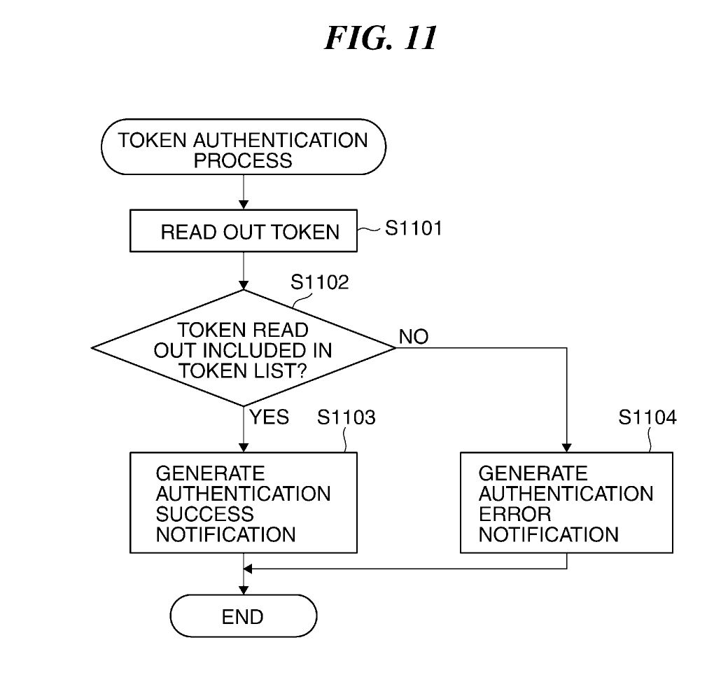

FIG. 11 is a flowchart of the token authentication process performed in the step S1003 in FIG. 10.

Referring to FIG. 11, first, the CPU 203a reads out the token attached to the token-attached command 900 from the token-attached command 900 (step S1101), and determines whether or not the token read out is included in the token list stored in the ROM 302c or the HDD 302d (step S1102). If it is determined in the step S1102 that the token read out is included in the token list, the CPU 203a generates the authentication success notification (step S1103), followed by terminating the present process, whereas if the token read out is not included in the token list, the CPU 203a generates the authentication error notification (step S1104), followed by terminating the present process.

Note that even when the token read out is included in the token list, the authentication error notification may be generated in any of predetermined cases. For example, in a case where a token with which is associated the user type information as the authentication information stored in the MFP 101 in advance is read out from the token list together with the user type information, and the user type information read out and the user type indicated by the attribute ID 911 included in the token-attached command 900 do not match each other (e.g. a case where the user type information read out is administrative user, but the user type indicated by the attribute ID 911 is guest user), the authentication error notification may be generated. Further, for example, in a case where print data is stored in the MFP 101, and the authentication information of a user who has stored the print data and the authentication information read out from the token list do not match each other, the authentication error notification may be generated.

According to the token generation process in FIG. 5, the token generation request command 600 is received (step S501), and user authentication processing is performed based on the user name 611, the password hash value 612, and the salt value 613, as well as the authentication information stored in the MFP 101 in advance (step S502). When the user authentication is successful (YES to the step S503), a token is generated (step S504). Here, the token generation request command 600 includes the header portion 601 and the command data portion 602. The user name 611, the password hash value 612, and the salt value 613 for use in performing user authentication processing are stored in the command data portion 602, and hence it is possible to eliminate the necessity of storing the user name 611, the password hash value 612, and the salt value 613 in the header portion 601, which are information for use in performing complicated user authentication. This makes it possible to eliminate the necessity of increasing the capacity of the header portion 601.

According to the reception process in FIG. 10 and the token authentication process in FIG. 11, the token-attached command 900 is received (YES to the step S1001), a token is read out from the token-attached command (steps S1003 and S1101), and user authentication is performed based on the token read out (steps S1102 to S1104). Here, the token-attached command 900 includes the header portion 901 and the command data portion 902. When the user authentication is performed by the token authentication process, since the header portion 901 stores only the token as the information for use in performing the user authentication, it is possible to eliminate the necessity of increasing the capacity of the header portion 901. As a result, it is possible to prevent reduction of the capacity of the command data portion 902 and thereby eliminate the necessity of dividing the command data to be stored in the command data portion 902. That is, it is possible to prevent a change in the data structure of the command data portion 902 included in the token-attached command 900 transmitted to the MFP 101.

According to the token generation process in FIG. 5, the reception process in FIG. 10, and the token authentication process in FIG. 11, the token generation request command 600 is received (step S501), and user authentication processing is performed based on the user name 611, the password hash value 612, and the salt value 613, as well as authentication information stored in the MFP 101 in advance (step S502). When the user authentication is successful (YES to the step S503), a token is generated (step S504). The generated token is registered in the token list in association with an ID, a password, and user type information which are stored in advance as the authentication information in the MFP 101 (step S505). The token authentication process is performed based on the token read out from the token-attached command 900 and the token list in which the token is registered (steps S1003, and S1101 to S1104). Therefore, even when a plurality of tokens exist, it is possible to manage the tokens in association with the respective users, whereby it is possible to perform proper user authentication.

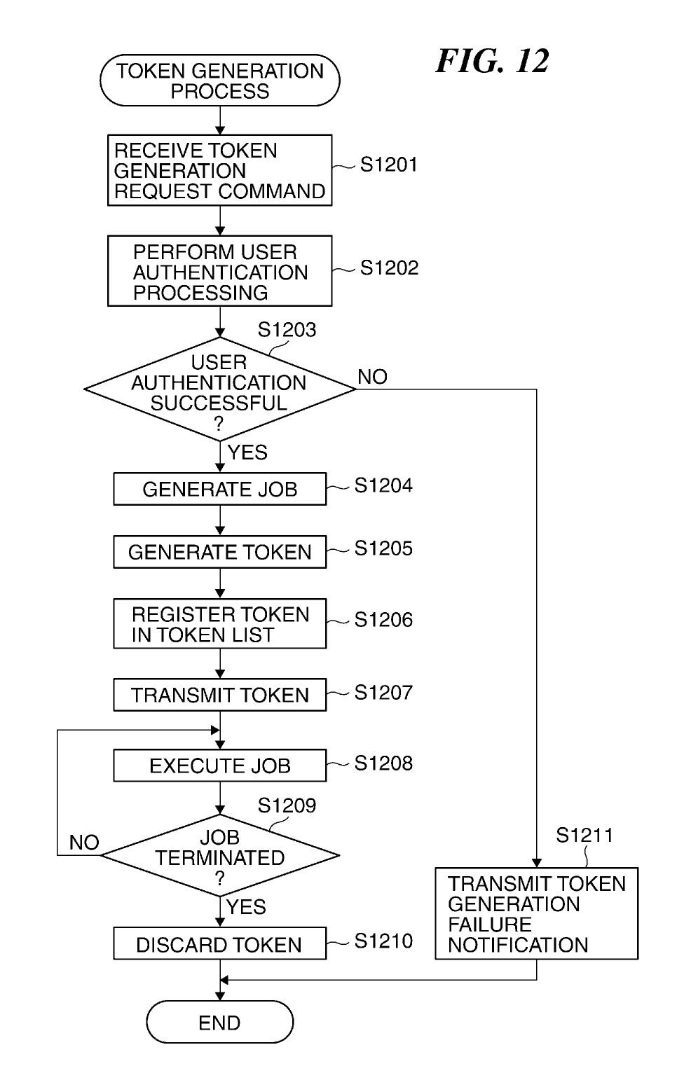

FIG. 12 is a flowchart of a variation of the token generation process in FIG. 5. The token generation process in FIG. 12 is performed by the CPU 203a of the MFP 101.

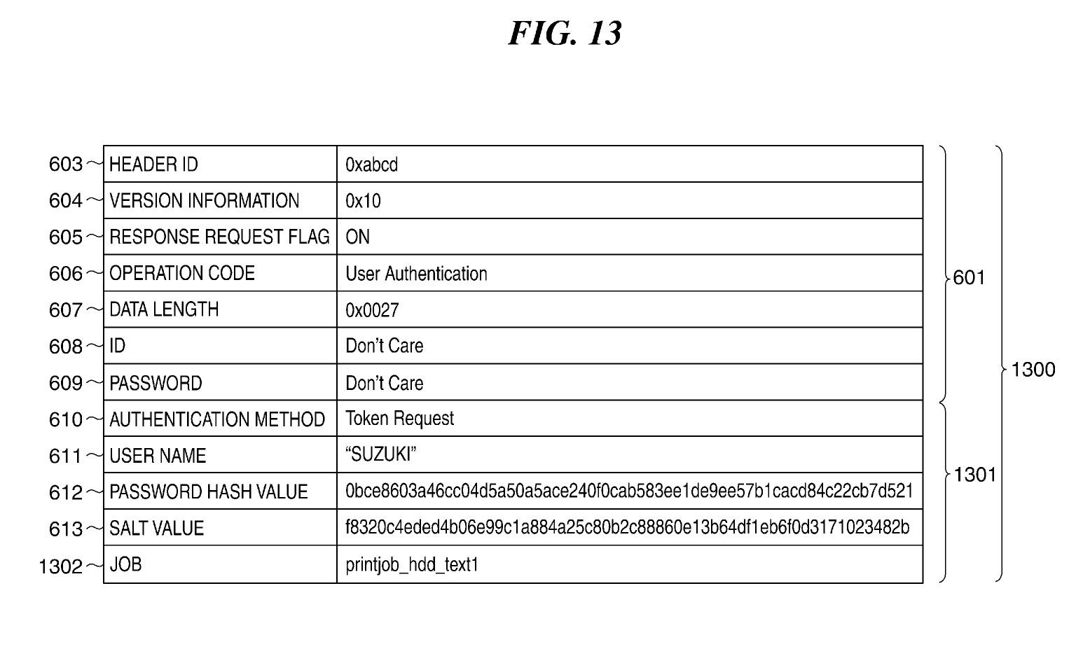

Referring to FIG. 12, first, the CPU 203a receives a token generation request command 1300 (see FIG. 13) (step S1201). The token generation request command 1300 has basically the same format (data structure) as the token generation request command 600 and is different from the token generation request command 600 in that a job 1302 is further stored in a command data portion 1301 corresponding to the command data portion 602 of the token generation request command 600. The job 1302 is a job to be performed by the MFP 101. For example, “printjob_hdd_text1” for printing print data “text1” is set as the job 1302, and the print data “text1” stored in the HDD 203d is printed in a step S1208, referred to hereinafter.

Referring back to FIG. 12, the CPU 203a performs user authentication processing based on the user name 611, the password hash value 612, and the salt value 613, as well as authentication information stored in the MFP 101 in advance (step S1202), and determines whether or not the user authentication is successful (step S1203).

If it is determined in the step S1203 that user authentication is not successful (fails), the CPU 203a transmits a token generation error notification that a token cannot be generated, to the PC 102 (step S1211), followed by terminating the present process, whereas if the user authentication is successful, the CPU 203a generates a job based on the job 1301 (step S1204), and further generates a token (step S1205). The generated token has the same format as the token generated in the step S504.

Then, the CPU 203a registers the generated token in the token list in association with the authentication information stored in the MFP 101 in advance (step S1206), transmits the token to the PC 102 (step S1207), executes the job (step S1208), and determines whether or not execution of the job is terminated (step S1209). If it is determined in the step S1209 that the execution of the job is not terminated, the CPU 203a returns to the step S1208, whereas if the execution of the job is terminated, the CPU 203a discards the token (step S1210), followed by terminating the present process.

According to the variation, shown in FIG. 12, of the token generation process, when the token generation request command 1300 includes the job 1302 in the command data portion 1301, a job is generated based on the job 1302 (step S1204), and a token is generated (step S1205). Therefore, it is possible to simultaneously request generation of a job and generation of a token, whereby it is possible to save time and effort for separately requesting generation of a job and generation of a token. Further, when the execution of the job is terminated, the token is discarded (step S1209), and hence it is possible to eliminate the necessity of requesting discarding of the token separately.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-015251 filed Jan. 29, 2015, which is hereby incorporated by reference herein in its entirety.

What is claimed is:

1. An image forming system including:
an image forming apparatus that performs user authentication by one of a first authentication method which does not use a token and a second authentication method which uses a token, and
an information processing apparatus that requests the user authentication to said image forming apparatus,
said image forming apparatus comprising:
a determination unit configured to receive a request command requesting the user authentication from said information processing apparatus, and determine, based on the request command, by which of the first authentication method and the second authentication method, the user authentication is to be performed;
a generation unit configured to generate a token based on the request command when it is determined that the user authentication is to be performed by the second authentication method;
a read-out unit configured to transmit the token to said information processing apparatus, receive a token-attached command to which the token is attached from said information processing apparatus, and read out the token from the token-attached command; and
an execution unit configured to perform the user authentication based on the token read out.

2. The image forming system according to claim 1, wherein the request command includes a first header portion that stores information indicative of a type of the user authentication and a first data portion that stores information for use in performing the user authentication, and the token-attached command includes a second header portion that stores the token and a second data portion that stores information other than the information for use in performing the user authentication.

3. The image forming system according to claim 2, wherein the information for use in performing the user authentication is an ID and a password for use in performing the user authentication.

4. The image forming system according to claim 1, wherein said image forming apparatus further comprises a reception unit configured to receive job-related information, and
wherein when the received job-related information is stored in the first data portion, a job is generated based on the job-related information, and the token is generated.

5. The image forming system according to claim 4, wherein when the generated job has been executed, the token is discarded.

6. The image forming system according to claim 1, wherein when it is determined that the user authentication is to be performed by the second authentication method, said generation unit generates a token list based on the request command, and
wherein said execution unit performs the user authentication based on the token read out and the token list.

7. An image forming apparatus that performs user authentication by one of a first authentication method which does not use a token and a second authentication method which uses a token, comprising:
a determination unit configured to receive a request command requesting the user authentication from an information processing apparatus connected to the image forming apparatus, and determine, based on the request command, by which of the first authentication method and the second authentication method, the user authentication is to be performed;
a generation unit configured to generate a token based on the request command when it is determined that the user authentication is to be performed by the second authentication method;
a read-out unit configured to transmit the token to the information processing apparatus, receive a token-attached command to which the token is attached from the information processing apparatus, and read out the token from the token-attached command; and
an execution unit configured to perform the user authentication based on the token read out.

8. The image forming apparatus according to claim 7, wherein the request command includes a first header portion that stores information indicative of a type of the user authentication and a first data portion that stores information for use in performing the user authentication, and the token-attached command includes a second header portion that stores the token and a second data portion that stores information other than the information for use in performing the user authentication.

9. A method of controlling an image forming system including an image forming apparatus that performs user authentication by one of a first authentication method which does not use a token and a second authentication method which uses a token, and an information processing apparatus that requests the user authentication to the image forming apparatus, comprising:
receiving a request command requesting the user authentication from the information processing apparatus;
determining, based on the request command, by which of the first authentication method and the second authentication method, the user authentication is to be performed;
generating a token based on the request command when it is determined that the user authentication is to be performed by the second authentication method;
transmitting the token to the information processing apparatus;
receiving a token-attached command to which the token is attached from the information processing apparatus;
reading out the token from the token-attached command; and
performing the user authentication based on the token read out.

10. The method according to claim 9 wherein the request command includes a first header portion that stores information indicative of a type of the user authentication and a first data portion that stores information for use in performing the user authentication, and the token-attached command includes a second header portion that stores the token and a second data portion that stores information other than the information for use in performing the user authentication.

11. A non-transitory computer-readable storage medium storing a computer-executable program for executing a method of controlling an image forming system including an image forming apparatus that performs user authentication by one of a first authentication method which does not use a token and a second authentication method which uses a token, and an information processing apparatus that requests the user authentication to the image forming apparatus,
wherein the method comprises:
receiving a request command requesting the user authentication from the information processing apparatus;
determining, based on the request command, by which of the first authentication method and the second authentication method, the user authentication is to be performed;
generating a token based on the request command when it is determined that the user authentication is to be performed by the second authentication method;
transmitting the token to the information processing apparatus;
receiving a token-attached command to which the token is attached from the information processing apparatus;
reading out the token from the token-attached command; and
performing the user authentication based on the token read out.

12. The storage medium according to claim 11 the request command includes a first header portion that stores information indicative of a type of the user authentication and a first data portion that stores information for use in performing the user authentication, and the token-attached command includes a second header portion that stores the token and a second data portion that stores information other than the information for use in performing the user authentication.
